(19) United States
(12) Patent Application Publication
(10) Pub. No.: US 2006/0036707 A1
(43) Pub. Date: Feb. 16, 2006

(54) Method and apparatus for routing images

(76) Inventors: Pawan Singh, Waukesha, WI (US); John D. Hoford, Pewaukee, WI (US)

Correspondence Address: QUARLES & BRADY LLP, 411 E. WISCONSIN AVENUE, SUITE 2040, MILWAUKEE, WI, 53202-4497, US

(21) Appl. No.: 10/917,573

(22) Filed: Aug. 13, 2004

(51) Int. Cl. G06F 15/16

(52) U.S. Cl. 709/217

(57) ABSTRACT

A method for exchanging images over a network includes associating an image router with an image repository. A first image request is received from a remote workstation in the image router. A second image request corresponding to the first image request is sent to the image repository. An image associated with the first image request is transferred from the image repository to the image router. The image is sent to the remote workstation. An imaging system includes, an image repository, a remote workstation, and an image router. The image repository is adapted to store a plurality of images. The remote workstation is adapted to issue a first image request for image data stored in the image repository. The image router is associated with the image repository and adapted to receive the first image request from the remote workstation and send a second image request corresponding to the first image request to the image repository. The image repository is adapted to transfer the image data associated with the second image request to the image router, and the image router is adapted to send the image data to the remote workstation.

### CROSS-REFERENCE TO RELATED APPLICATIONS

Not applicable.

### STATEMENT REGARDING FEDERALLY SPONSORED RESEARCH OR DEVELOPMENT

Not applicable

### BACKGROUND OF THE INVENTION

The field of the invention relates generally to medical imaging methods and systems, and more particularly to a method and apparatus for routing medical images.

Image archiving and communication systems have become an extremely important component in the management of digitized image data, particularly in the field of medical imaging. Such systems often function as central repositories of image data, receiving the data from various sources. The image data is stored and made available to various individuals for viewing, analysis, or diagnosis. There are many types of medical imaging systems. The primary distinction between the different systems is the medical imaging modality that is used, such as, x-ray, magnetic resonance, ultrasound, nuclear, etc.

In some cases, images are stored on the scanner that generated the image. A clinician or other user of the image may access the scanner and request a transfer of a particular image for viewing at their location. To facilitate image exchange and viewability across different scanner types and viewing hardware, industry standards have been promulgated defining data formats and transfer protocols. One such standard is the Digital Imaging and Communications in Medicine (DICOM) standard that defines data representation formats and hence achieve platform independence. The DICOM standard was developed by the American College of Radiology and the National Electrical Manufacturers Association to provide a standard for transferring medical images and associated information between devices. The data types in DICOM are well defined, and are hardware independent. Predefined DICOM tags can be used to identify data that is being transmitted and packets can be easily extended by application programmers.

One security aspect inherent in the protocol implemented under the DICOM standard is that users wishing to access images from a particular data repository (e.g., scanner) must be recognized as trusted hosts by the repository. Typically, DICOM networks are implemented using an transmission control protocol/internet protocol (TCP/IP) protocol for transferring data in packets. Each entity has an assigned name and IP address. To allow a user to access data from a repository, the user's name and IP address are associated with the repository as a trusted host. Subsequently, when the repository receives a request for an image, it checks its trusted host list and sends the image if the requestor is trusted.

As computer networks become increasingly flexible with some users being mobile it is common to let the network dynamically assign a user an IP address. The IP address assigned to a user may change periodically based on network administration techniques, location, usage habits, connection modality (e.g., wired or wireless connection), etc. Typically, such IP address changes are entirely transparent to the user. After such a change, when a user requests an image from the repository, the IP address and name will no longer match the trusted host list, and the request will be rejected. Subsequently, the user must manually reconfigure the trusted host list for the repository with the new IP address information. In some cases this may require that the user physically go to the repository and enter the new IP address information, enter the IP address information using a remote interface, or request that a system administrator modify the trusted host list for the repository. This process may be cumbersome and time consuming. The problem may be exacerbated by the number of scanners or other repositories present on a network. The trusted host list for each scanner would require updating each time an IP address is changed.

This section of this document is intended to introduce various aspects of art that may be related to various aspects of the present invention described and/or claimed below. This section provides background information to facilitate a better understanding of the various aspects of the present invention. It should be understood that the statements in this section of this document are to be read in this light, and not as admissions of prior art. The present invention is directed to overcoming, or at least reducing the effects of, one or more of the problems set forth above.

### BRIEF SUMMARY OF THE INVENTION

One aspect of the present invention is seen in a method for exchanging images over a network. The method includes associating an image router with an image repository. A first image request is received from a remote workstation in the image router. A second image request corresponding to the first image request is sent to the image repository. An image associated with the first image request is transferred from the image repository to the image router. The image is sent to the remote workstation.

Another aspect of the present invention is seen in an imaging system including an image repository, a remote workstation, and an image router. The image repository is adapted to store a plurality of images. The remote workstation is adapted to issue a first image request for image data stored in the image repository. The image router is associated with the image repository and adapted to receive the first image request from the remote workstation and send a second image request corresponding to the first image request to the image repository. The image repository is adapted to transfer the image data associated with the second image request to the image router, and the image router is adapted to send the image data to the remote workstation.

These and other objects, advantages and aspects of the invention will become apparent from the following description. In the description, reference is made to the accompanying drawings which form a part hereof, and in which there is shown a preferred embodiment of the invention. Such embodiment does not necessarily represent the full scope of the invention and reference is made, therefore, to the claims herein for interpreting the scope of the invention.

### BRIEF DESCRIPTION OF THE SEVERAL VIEWS OF THE DRAWINGS

The invention will hereafter be described with reference to the accompanying drawings, wherein like reference numerals denote like elements, and:

FIG. 1 is a simplified block diagram of an imaging system in accordance with one aspect of the present invention; and

FIG. 2 is a diagram illustrating the flow of an image in the system of FIG. 1.

### DETAILED DESCRIPTION OF THE INVENTION

One or more specific embodiments of the present invention will be described below. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

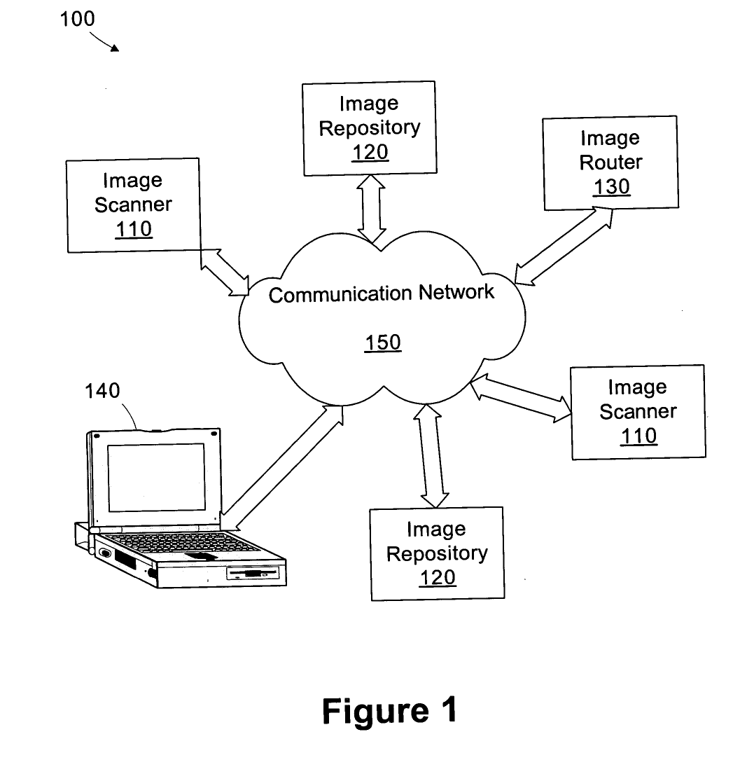

Referring now to FIG. 1, a simplified block diagram of an imaging system 100 in accordance with one aspect of the present invention is shown. The imaging system 100 includes one or more image scanners 110, one or more image repositories 120, an image router 130 and a remote workstation 140, all communicating over a communication network 150. In one embodiment, an image repository 120 may be implemented by a general purpose computer or workstation executing a database software application that includes one or more data structures for storing image data. In some embodiments, the image scanners 110 may also function as image repositories, and where the term repository is used, it may refer either to an image scanner 110 or the image repository 120.

As used herein, the term remote indicates that the user is at a location separate from the image scanner 110 or repository 120, such that an requested image must be transferred over the communication network 150 to the remote workstation 140. Remote does not imply any relationship regarding the physical proximity of the remote workstation 140 and the repository 120. The communication network 150 may be of a variety of forms, including, but not limited to, a local area network (LAN), a wide area network (WAN), the Internet, etc. The communication network 140 may employ hard-wired (e.g., Ethernet) or wireless (e.g. 802.11) connections.

The application of the present invention is not limited to any particular imaging application or image type. Exemplary image include computed tomography (CT) images, x-ray images, magnetic resonance (MR) images, etc.

In general operation, the remote workstation 140 associates itself with the image router 130 for accessing images. It is contemplated that the remote workstation 140 may be a mobile device, such as a notebook computer, that may have its IP address periodically changed. Hence, the remote workstation 140 associates with the image router 130 using only a logical name. Depending on the particular implementation, various security techniques, such as passwords, authentication keys, etc. may be employed for enhancing security between the remote workstation 140 and the image router 130. Such techniques are well known to those of ordinary skill in the art, so they are not described in detail herein.

The image router 130 associates itself with the scanners 110 and the image repositories 120 using a typical DICOM standard registration process by registering as a trusted host with the scanners 110 and repositories 120 based on its logical name and IP address. The IP address and name of the image router 130 is listed on the trusted host list of each image storing entity, and typically, the IP address of the image router 130 is fixed. Hence, once the image router 130 is properly associated, it will remain on the trusted host list of the scanners 110 and repositories 120.

The image router 130 may be implemented using software running on a general purpose microprocessor, firmware (e.g., an embedded ROM), or dedicated hardware. The image router 130 functions mainly to repeat requests from the remote workstation 140 for particular images. Because the remote workstation 140 associates itself with the image router 130 without requiring the use of its IP address, the IP address of the remote workstation 140 may be dynamically assigned by the communication network 150 without interrupting the user's ability to retrieve images from the scanners 110 or repositories 120.

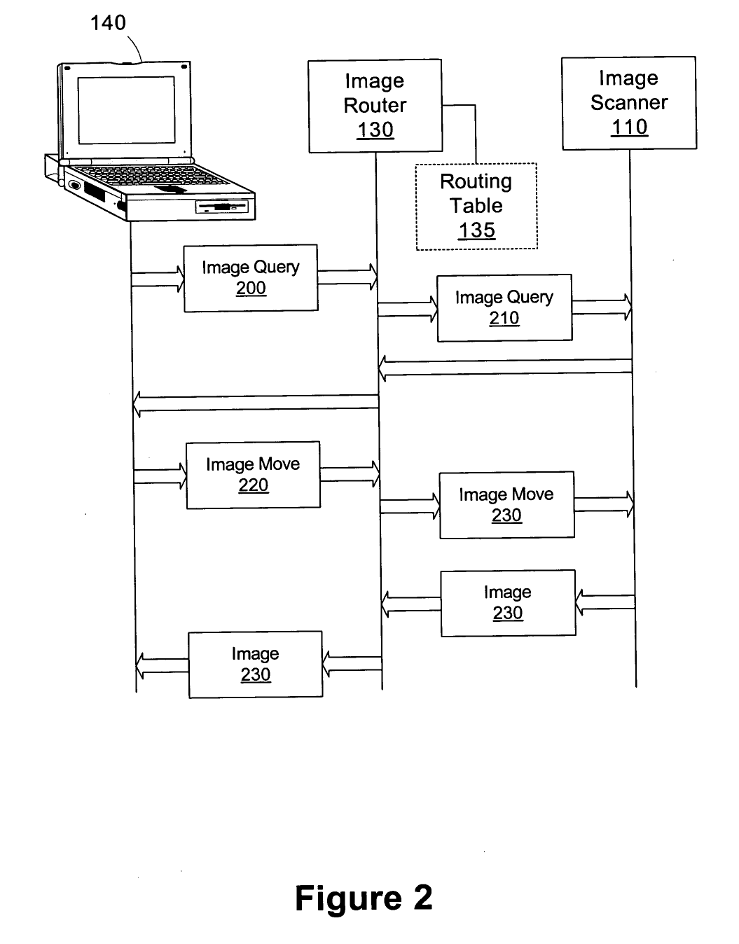

Turning now to FIG. 2, a simplified diagram illustrating the transfer of an image to the remote workstation 140 is provided. The remote workstation 140 issues a query 200 to a scanner 110 requesting information regarding an image. The image router 130 receives the query 200 and issues a second query 210 to the scanner 110. Although the image router 130 intercepts the query 200, from the viewpoint of the remote workstation 140, the query 200 is directed to the scanner 110. In response to the query 210, the scanner 110, after recognizing the image router 130 as a trusted host, returns information regarding matching studies and data sets. The image router 130 maintains a routing table 135 that stores requests from various entities, such as the remote workstation 140. Upon receiving the results of the query, the image router 130 checks the routing table 135 to determine the identity of the requesting entity and forwards the query data back to the remote workstation 140.

Subsequently, the remote workstation 140 issues a move request 220 to transfer an image from the scanner 110 to the remote workstation 140. The image router 130 again intercepts the move request 220 and issues a corresponding move request 230 instructing the scanner 110 to move the requested image to the image router 130. Again, after recognizing the image router 130 as a trusted host, the scanner 110 moves the image 230 to the image router 130. The image router 130 accesses the routing table 135 to identify the remote workstation 140 as the requesting entity, and delivers the image 230.

In the transfer scenario described above, the presence of the image router 130 was transparent to both the remote workstation 140 and the scanner 110. The remote workstation issues a command as if it were directly accessing the scanner 110. The image router 130 issues a subsequent command designating itself as the requester. The scanner 110 recognizes the image router 130 as a trusted host due its prior association and sends the requested data to the image router, which in turn forwards the data back to the requesting remote workstation 140. From the standpoint of the remote workstation 140, it appears that the request was issued to and filled by the scanner 110. From the standpoint of the scanner 110, it appears that the request was issued by and completed by the image router 130. Hence, the interfaces for the remote workstation 140 and the scanner 110 need not be modified to implement the present invention.

The centralized image routing functions performed by the image router 130 provide other opportunities for efficiency and/or tracking. First, the image scanner 130 may store a cache of recently requested images. Upon receiving a request for a cached image, the image can be sent directly to the requesting entity without requiring a transfer from the scanner 110 or the image repository 120. In some embodiments, the image router 130 may query the scanner 110 or the image repository 120 to determine if the cached image is still current prior to transferring the cached image. Even with such snooping enabled, the transfer time is decreased because the cached image need not be transferred by the scanner 110 or the image repository 120 to the image router 130 if it is still current.

Another advantageous function that may be performed by the image router 130 is audit tracking or traffic monitoring. The image router 130 may store an audit trail for all of the images listing the requesting entities and transfer times. The image router 130 may also store traffic data and report on network activity (e.g., number of requests or bytes transferred) for a given DICOM network or subset of the network.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

We claim:

1. A method for exchanging images over a network, comprising:
associating an image router with an image repository;
receiving a first image request from a remote workstation in the image router;
sending a second image request corresponding to the first image request to the image repository;
transferring image data associated with the first image request from the image repository to the image router; and
sending the image data to the remote workstation.

2. The method of claim 1, wherein the remote workstation has a dynamic network address and an entity name, and the method further comprises associating the remote workstation with the image router based on the entity name.

3. The method of claim 2, wherein the image router has a static network address and the method further comprises associating the image router with the image repository based on the static network address.

4. The method of claim 1, wherein associating the image router with the image repository further comprises registering the image router as a trusted host with the image repository based on a static network address and an entity name of the image router with the image repository.

5. The method of claim 1, further comprising storing a record of at least one of the first and second image requests in an audit log.

6. The method of claim 1, further comprising calculating a network traffic statistic based on at least one of the first and second image requests, the transfer of the image to the image router, and the forwarding of the image to the remote workstation.

7. The method of claim 1, further comprising storing the image data in a cache associated with the image router.

8. The method of claim 1, further comprising:
logging the first image request in a routing table associated with the image router; and
accessing the routing table to identify the remote workstation as the issuer of the first message request responsive to receiving the image data from the image repository.

9. The method of claim 1, further comprising generating the first image request, the first image request comprising at least one of an image query and an image move request.

10. An imaging system, comprising:
an image repository adapted to store a plurality of images;
a remote workstation adapted to issue a first image request for image data stored in the image repository;
an image router associated with the image repository and adapted to receive the first image request from the remote workstation and send a second image request corresponding to the first image request to the image repository, wherein the image repository is adapted to transfer the image data associated with the second image request to the image router, and the image router is adapted to send the image data to the remote workstation.

11. The system of claim 10, wherein the remote workstation has a dynamic network address and an entity name, and the remote workstation is associated with the image router based on the entity name.

12. The system of claim 11, wherein the image router has a static network address and the image router is associated with the image repository based on the static network address.

13. The system of claim 10, wherein the image router is registered with the image repository as a trusted host based on a static network address and an entity name of the image router.

14. The system of claim 10, wherein the image router is adapted to store a record of at least one of the first and second image requests in an audit log.

15. The system of claim 10, wherein the image router is adapted to calculate a network traffic statistic based on at least one of the first and second image requests, the transfer of the image data to the image router, and the forwarding of the image data to the remote workstation.

16. The system of claim 10, wherein the image router is adapted to store the image data in a cache.

17. The system of claim 10, wherein the image router is adapted to log the first image request in a routing table associated with the image router and access the routing table to identify the remote workstation as the issuer of the first message request responsive to receiving the image data from the image repository.

18. The system of claim 10, wherein the first image request comprises at least one of an image query and an image move request.

19. A system for exchanging images over a network, comprising:
means for storing a plurality of images;
means for issuing a first image request for image data stored in means for storing the plurality of images;
means for receiving the first image request from the remote workstation;
means for sending a second image request corresponding to the first image request to the means for storing the plurality of images;
means for receiving the image data from the means for storing the plurality of images and sending the image data to the means for issuing the first image request.
